(19) United States
(12) Patent Application Publication
(10) Pub. No.: US 2022/0179919 A1
(43) Pub. Date: Jun. 9, 2022

(54) EVENT PREDICTION DEVICE AND EVENT PREDICTION METHOD

(71) Applicant: Singular Perturbations Inc., Tokyo (JP)

(72) Inventors: Mami Kajita, Nagoya-shi Aichi (JP); Seiji Kajita, Nagoya-shi Aichi (JP)

(21) Appl. No.: 16/337,447

(22) PCT Filed: Mar. 27, 2019
(86) PCT No.: PCT/JP2019/013483

§ 371 Date: Feb. 28, 2022

(51) Int. Cl. G06F 17/13; G06Q 50/26

(52) U.S. Cl. CPC G06F 17/13; G06Q 50/265

(57) ABSTRACT

[Problem] To improve the prediction accuracy even when the number of data is small in the event occurrence prediction apparatus that predicts the future occurrence density of the specific event based on the history data of the specific event occurred in the past.

[Solution] The event prediction apparatus has a prediction formula construction part 10 and prediction part 30. The prediction formula construction part 10, assuming an occurrence density of the specific event is given as a function ρ(t, x) of a time t and a region specifying variable x which specifies the region where the specific event occurs and the function ρ(t, x) is given as a mapping F[ρ(t, x)+{f}] of an external factor {f} and the function ρ(t, x), obtains F[ρ(t, x)+{f}] from history data of the specific events occurred in the past, and expresses the function ρ(t, x) as the occurrence time t and the region specifying variable x. The prediction part 30 predicts the occurrence density of the specific event by inputting a future time and a value specifying a region into ρ(t, x).

### TECHNICAL FIELD

This invention relates to an event prediction apparatus and an event prediction method.

### BACKGROUND ART

There is a case that police officers focused on the area of caution in California, USA, where crimes are likely to occur, and the subsequent crimes were suppressed. In addition, there is a case of improving the prediction accuracy of the crime occurrence density by using the algorithm proposed for aftershock prediction of an earthquake.

Prediction of the occurrence of a crime is performed by using, for example, a Self-Exciting Point Process (SEPP) model. In the SEPP model, the crime occurrence density at a specific location and at a specific time in the future is indicated by the sum of the effects of crime events occurred in the past. More specifically, it is assumed that the effect of a past crime event on the crime density at a particular location and a particular time is expressed as a function of the distance between the location for prediction and the location of the past crime event and the time between the time for prediction and the time when the past crime event occurred. In addition, it is calculated by adding each effect on the crime occurrence density of the every crime occurred in the past.

Expressing the effect of crime events occurred in the past on the crime occurrence density as g (Δt, Δx) by using the distance Δx and the period of time Δt, between the position and the time currently focused and the position and the time where and when the event occurred in the past (scaled in appropriate length and time, respectively), there is a method in which it is expressed as g (Δt, Δx)=1/((1+Δt) (1+Δx)) (Prospective Hotspot Method). There is a method in which the effect g(Δt, Δx) of the crime occurrence event in the past on the occurrence density at the location x and time t of the crime in the past is constructed from the history data of the crime occurrence event in the past, by using the Expectation Maximization Algorithm.

There is a method in which a prediction formula construction part and a prediction part is provided to improve the accuracy of prediction of the occurrence density of the event in the future based on the history data of the event occurrence in the past. The prediction formula construction part assumes a occurrence density of a specific event is given by the function ρ(t, x) of the occurrence time t of the specific event and a region specifying variable x which specifies the region where the specific event occurs and ρ(t, x) is given by an external factor {f} and a mapping F[ρ (t, x)], obtains the mapping F[ρ(t, x)+{f}] from the history data of the specific event occurred in the past, and expresses function ρ(t, x) as a function of the occurrence time t and the region specifying variable x. The prediction part predicts the occurrence density of the specific event by inputting values specifying a time in the future and a region into the function ρ.

### PRIOR ART DOCUMENT

### Patent Document

[Patent Document 1] U.S. Pat. No. 8,949,164
[Patent Document 2] U.S. Pat. No. 9,129,219
[Patent Document 3] WO2017/222030

### DISCLOSURE OF THE INVENTION

### Problem to be Solved by the Invention

When the effect g(Δt, Δx) on the occurrence density in the distance difference Δx and the time difference Δt from the crime which is a past occurrence event is expressed by a specific function, the accuracy may not be improved because of discrepancy from the reality. Further, when the effect g(Δt, Δx) is constructed by using the Expectation Maximization Algorithm, the accuracy may not be high in the prediction by machine learning with the small number of data.

Therefore, an object of the present invention is to improve the prediction accuracy even when the number of data is small in the event occurrence prediction apparatus that predicts the future occurrence density of the specific event based on the history data of the specific event occurred in the past.

### Means for Solving the Problem

To achieve the above described object, according to an aspect of the present invention, there is provided an event prediction apparatus predicting feature quantity vector ρ(t) at time t based on history data of specific events occurred in a passed, the apparatus comprising; a prediction formula construction part defining a matrix c(t) as

$${c}_{j ′ j} ( t ) = 〈 \frac{{ρ}_{j ′} ( t + {t}_{0} )}{{ρ}_{j} ( {t}_{0} )} 〉 , \qquad [ Equation 1 ]$$

obtaining

Φ(t)=c(t)c(t=0)⁻¹, [Equation 2]

obtaining Laplace transform Φ(z) of Φ(t),

obtaining Green's function G(z) using a constant gamma as

G(z)=Φ(z)(γΦ(z)+Δt)⁻¹, [Equation 3]

and obtaining G(t) by applying Laplace transform to the G(z); and a prediction part using G(t) obtained by the prediction formula construction part and obtaining the feature quantity vector ρ(t) of the specific events by inputting a time t in a future into

ρ(t)=γG(t)⊗ρ(t)+ΔtG(t)ρ(t=0). [Equation 4]

According to another aspect of the present invention, there is provided an event prediction method predicting feature quantity vector ρ(t) at time t based on history data of specific events occurred in a passed, the method comprising; a prediction formula construction step defining a matrix c(t) as

$${c}_{j ′ j} ( t ) = 〈 \frac{{ρ}_{j ′} ( t + {t}_{0} )}{{ρ}_{j} ( {t}_{0} )} 〉 , \qquad [ Equation 5 ]$$

obtaining

Φ(t)=c(t)c(t=0)⁻¹, [Equation 6]

obtaining Laplace transform Φ(z) of Φ(t),

obtaining Green's function G(z) using a constant gamma as

G(z)=Φ(z)(γΦ(z)+Δt)⁻¹, [Equation 7]

and obtaining G(t) by applying Laplace transform to the G(z); and a prediction step using G(t) obtained by the prediction formula construction part and obtaining the feature quantity vector ρ(t) of the specific events by inputting a time t in a future into

ρ(t)=γG(t)⊗ρ(t)+ΔtG(t)ρ(t=0). [Equation 8]

According to another aspect of the present invention, there is provided an event prediction system predicting feature quantity vector ρ(t) at time t based on history data of specific events occurred in a passed, the apparatus comprising; a prediction formula construction part defining a matrix c(t) as

$${c}_{j ′ j} ( t ) = 〈 \frac{{ρ}_{j ′} ( t + {t}_{0} )}{{ρ}_{j} ( {t}_{0} )} 〉 , \qquad [ Equation 5 ]$$

obtaining

Φ(t)=c(t)c(t=0)⁻¹, [Equation 10]

obtaining Laplace transform Φ(z) of Φ(t),
obtaining Green's function G(z) using a constant gamma as

G(z)=Φ(z)(γΦ(z)+Δt)⁻¹, [Equation 11]

and obtaining G(t) by applying Laplace transform to the G(z); a prediction part using G(t) obtained by the prediction formula construction part and obtaining the feature quantity vector ρ(t) of the specific events by inputting a time t in a future into

ρ(t)=γG(t)⊗ρ(t)+ΔtG(t)ρ(t=0); [Equation 12]

a terminal transmitting an occurrence of the specific event as the history data; and a server making the prediction formula construction part to obtain G(t) again when a new history data is obtained by receiving the new history data from the terminal.

### Advantages of the Invention

According to the present invention, it is possible to improve the prediction accuracy even when the number of data is small in the event occurrence prediction apparatus that predicts the future occurrence density of the specific event based on the history data of the specific event occurred in the past.

### BRIEF DESCRIPTION OF THE DRAWINGS

FIG. 1 is a block diagram of a event occurrence prediction apparatus according to an embodiment of the present invention.

FIG. 2 is a flowchart of an event occurrence prediction method using the event occurrence prediction apparatus according to an embodiment of the present invention.

FIG. 3 is a chart showing an evaluation example of the time t dependence of the kernel function g in the crime occurrence rate prediction using the event occurrence prediction apparatus according to an embodiment of the present invention.

FIG. 4 is a contour line chart showing a crime occurrence prediction result using the event occurrence prediction apparatus according to an embodiment of the present invention.

### EMBODIMENT

An embodiment of an event prediction apparatus according to the present invention will be described by referring to the drawings. This embodiment is only an example and the present invention is by no means limited to this embodiment. The same symbols are given to same or similar configurations, and duplicated descriptions may be omitted.

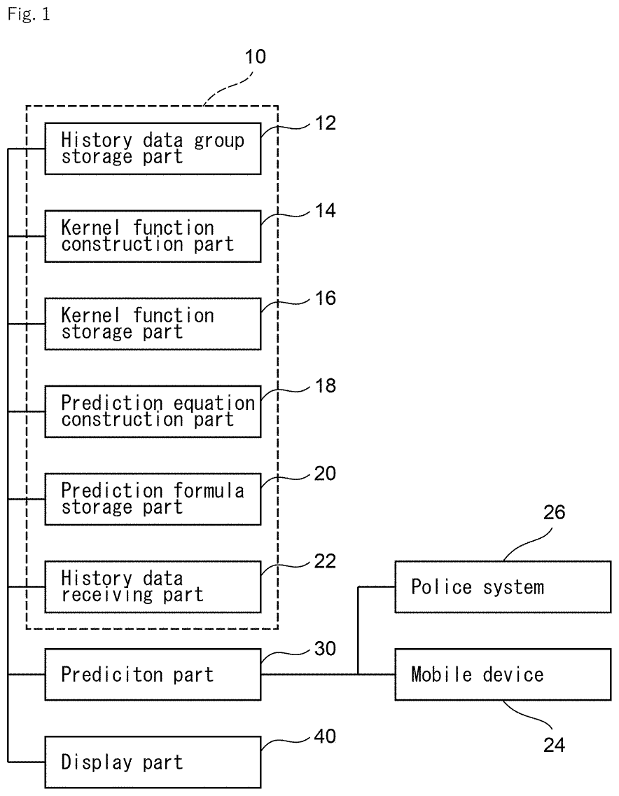

FIG. 1 is a block diagram of a event occurrence prediction apparatus according to an embodiment of the present invention.

In the present embodiment, it predicts an occurrence density at a specific time and region of a crime (a specific event) such as trespassing. Here, the region specifies the location on the map where the crime occurs. When the specific event is a crime such as a fraud in the Internet or a spam phone call, the region specifies the location on the Internet such as URL or a phone number.

The event occurrence prediction apparatus has a prediction formula construction part 10 and a prediction part 30.

The prediction formula construction part 10 assumes a occurrence density of a specific event is given by the function ρ(t, x) of the occurrence time t of the specific event and a region specifying variable x which specifies the region where the specific event occurs and ρ(t, x) is given by an external factor {f} and a mapping F[ρ(t, x)], obtains the mapping F[ρ(t, x)+{f}] from the history data of the specific event occurred in the past, and expresses function ρ(t, x) as a function of the occurrence time t and the region specifying variable x. The external factor {f} is a factor that affects the occurrence density of the specific event other than history data, such as an environmental factors such as weather conditions and geographical structure, and a patrol conditions. The prediction formula construction part 10 has, for example, a history data group storage part 12, a kernel function construction part 14, a kernel function storage part 16, a prediction formula construction part 18, a prediction formula storage part 20, and a history data receiving part 22.

The prediction part 30 calculates the occurrence density of a specific event as a function of the date and time t and the place x by using the prediction formula constructed by the prediction formula construction part 10, that is, the function g(t, x) and the data.

The event occurrence prediction apparatus may have a display part 40. The display part 40 recognizably displays the occurrence density of the specific event calculated by the prediction part 30. The display part 40 displays contour lines of the occurrence density of a specific event on a map, for example.

Next, a method of calculating the occurrence density of the specific event in the present embodiment. Consider the occurrence density ρ(t, x) of the specific event at time t and region x. Assume that the occurrence density ρ(t, x) is a mapping of itself. That is to say, suppose,

ρ(t,x)=F[ρ(t,x)+{f}] (1).

Here, {f} is considered to be an external factor such as a season, an environmental factor, and a patrol situation.

The prediction formula construction part 10 solves the problem of constructing the mapping F by using the history data group of the occurrence of the specific event in the past. Here, the occurrence history data group of a specific event is a set of a plurality of history data. The history data is a set of a time t when a specific event occurred and a region specifying variable x that specifies the region where the specific event occurred. The history data may include an index indicating the type of the specific event.

The mapping F[ρ(t, x)+{f}] can be assumed to be, for example, the solution of a partial differential equation.

Also, the solution of a partial differential equation can be expressed using, for example, a kernel function (it may be called as a Green's function, a response function, or an integral nucleus).

For example, in the case of one variable, the occurrence density ρ(t, x) can be assumed to satisfy the following equation.

[Equation 13]

ρ(t,x)=γ∫₀^{t}dt′∫dx′g(t,t′,x,x′)(ρ(t′,x′)+f)+Δt∫dx′g(t,0,x,x′)ρ(t=0,x′), (2)

Here, γ can be determined according to the event to be described.

It should be noted that there are some variations in the function form of ρ(t, x) and external factor dependency of the kernel function of the first term on the right side, and the form of the second term. Hereinafter, discussion will be made by giving the simplest example.

Further, it may be assumed that the kernel function g(t, t′, x, x′) can be written as a function of the time difference and the distance difference between the past event and the present time and location. For example, the form of the evolution equation can be as follows.

[Equation 14]

ρ(t,x)=γ∫dt′dx′g(t−t′,x−x′)ρ(t′,x′)+Δt∫dx′g(t,x−x′)ρ(t=0,x′), (3)

For example, in the condition where one crime occurs every day (steady solution), by adding a request that λ(t, x) and the steady solution of ρ(t, x) of the SEPP model are equal, γ can be obtained as γ=log 2. In general, the coefficient γ can be uniquely determined by imposing a constraint such that ρ(t) matches the conditional intensity λ(t) of the SEPP model in some ideal state (for example, steady state).

When this evolution equation is Fourier transformed with respect to the region x and Laplace transformed with respect to the time t, the following equation is obtained.

[Equation 15]

g(z,k)=Φ(z,k)/(Δt+γΦ(z,k)) (4)

Φ(t,k)=<ρ(t+t₀,k)/ρ(t₀,k)>ₜ₀ (5)

The history data of crime in the past, that is, the occurrence density ρ(t, k) in the certain region k at a certain time t, is used to obtain Φ(t, k). Here, the occurrence density ρ(t, x) in the past time t and the region x takes a positive integer value. Assuming that the occurrence time is tᵢ and the occurrence region is xᵢ for the i-th specific event, ρ(tᵢ, xᵢ)=1 if no other event occurs at the same time and the same region. Once Φ(t, k) is obtained, g(z, k) is obtained using that Φ. Once g(t, x) is obtained, the prediction of crime density λ(t, x) is given by substituting it into the spatiotemporal kernel term of the Self-Exciting Point Process (SEPP) model.

An example of the calculation method of λ(t, x) is given below.

λ(t,x)=Σ_{ti<tg}(t−tᵢ,x−xᵢ) (6)

Here, the sum of (6) is the sum of all the specific events that occurred before the time t.

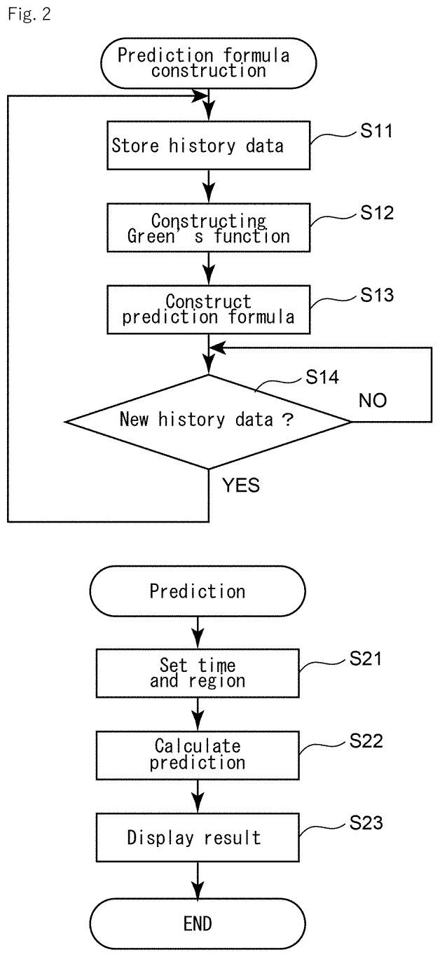

FIG. 2 is a flowchart of an event occurrence prediction method using the event occurrence prediction apparatus according to the present embodiment.

This event occurrence prediction method is divided into a prediction formula construction phase and a prediction phase. In the prediction formula construction phase, assuming that a occurrence density of a specific event is given by the function ρ(t, x) of the occurrence time t of the specific event and a region specifying variable x which specifies the region where the specific event occurs and ρ(t, x) is given by an external factor {f} and a mapping F[ρ(t, x)], the mapping F[ρ(t, x)+{f}] is obtained from the history data of the specific event occurred in the past, and the function ρ(t, x) is expressed as a function of the occurrence time t and the region specifying variable x. In the prediction phase, the occurrence density of the specific event is predicted by using the mapping F[ρ(t, x)+{f}] and the history data. More specifically, it is as follows.

In the prediction formula construction phase, at first, the history data in the past is stored in the history data group storage part 12 (S11). There may be a plurality of past history data.

Next, the kernel function construction part 14 obtains the kernel function g(z, k) from the equations (3) and (4) using the history data group in the past stored in the history data group storage part 12 (S12). The kernel function g(z, k) derived by the kernel function construction part 14 is stored in the kernel function storage part 16. This kernel function is stored as a table of values at the discretized time z and the region specifying variable k that identifies the discretized region.

Once the kernel function g(z, k) is obtained, applying the Laplace inverse transform and the Fourier inverse transform, the prediction formula construction part 18 construct a function that gives the predicted crime density λ(t, x) predicting the occurrence density of a specific event from the formulas (5) and (6) (S13). The predicted crime density λ(t, x) constructed by the prediction formula construction part 18 is stored in the prediction formula storage part 20. This predicted crime density λ is stored as a table of values in the discretized time t and the region specifying variable that specifies the discretized region.

After the function of the predicted crime density λ is constructed, the history data receiving part 22 monitors the input of new history data (S14). For example, when a general user inputs the fact that a crime has occurred through a mobile terminal 24 such as a smartphone, the history data is received by the history data receiving part 22. It is assumed that the mobile terminal 24 is installed with an application for inputting new history data when a general user witnesses a crime and transmitting the history data to the history data receiving part 22. Alternatively, the history data may be transmitted from the police system 26 owned by the information providing organization such as the police to the history data receiving part 22.

The history data receiving part 22 continues monitoring repeatedly each time after new history data is input. When new history data is input to the history data receiving part 22, the history data is stored in the history data group storage part 12, and the process returns to step S11. As a result, the steps S11 to S13 are performed again, a new function of the predicted crime density λ is constructed, and the function is stored in the prediction formula storage part 20.

In the prediction phase, at first, the time and region for predicting the predicted crime density are set (S21). The time for prediction may be a specific time or may have a range. The time for prediction is, for example, a predetermined period from the present. The region for prediction may be a specific position or may have an area. The region for prediction is, for example, the entire region where history data is collected for constructing a prediction formula. The prediction part 30 sets the time and region for prediction.

Next, at the time and region set in step S21, the prediction part 30 receives the prediction formula from the prediction formula storage part 20 and calculates the prediction crime density λ (S22). If the time and region for prediction have a width or spread, the calculation of the predicted crime density Δ is repeated for each discretized time and region.

The calculated predicted crime density λ is displayed on the display unit 40 (S23). The predicted crime density λ displayed so that it can be recognized by humans is referred to by police officers and the like, and is used as a reference for patrol activities. Alternatively, the predicted crime density λ displayed on the mobile terminal 24 is used by the user of the mobile terminal 24 for actions to avoid crime.

A crime occurred in the past induces a next crime at a location that is temporally and spatially separated. The greater the time difference and distance, the less likely the effect will be. For example, in the case of an illegal invasion in Los Angeles, Calif., when a crime occurs, the reoccurrence density within 1 m increases 1-2 days and 7 days later. Considering that each of the past crime history data induces a crime at a certain time and a certain position in the future, the occurrence density ρ of crime in the future is given as a mapping F of the occurrence density ρ of crime in the past. Therefore, in this embodiment, it is assumed that ρ(t, x)=F[ρ(t, x)+{f}], and a kernel function for the density field of occurrence density of crime is constructed from historical data.

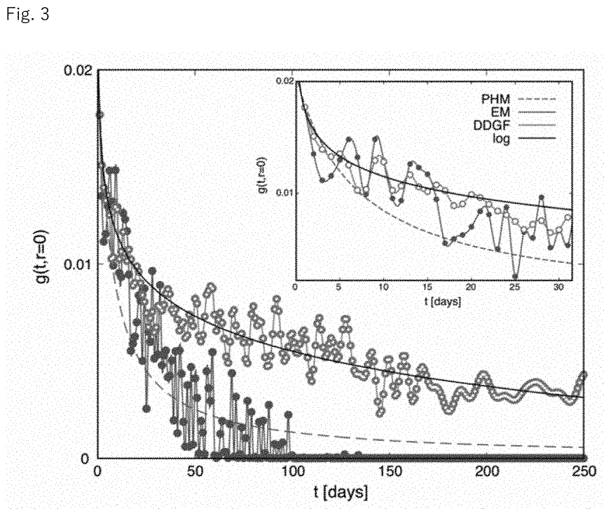

FIG. 3 is a chart showing an evaluation example of the time t dependence of the kernel function g in the crime occurrence rate prediction using the event occurrence prediction apparatus of the present embodiment. The horizontal axis of FIG. 3 is the time between times t, and the vertical axis is the value of the kernel function g.

As shown in FIG. 3, the kernel function g tends to decrease as time increases. However, as shown in FIG. 3, the kernel function g is not monotonically decreasing with time.

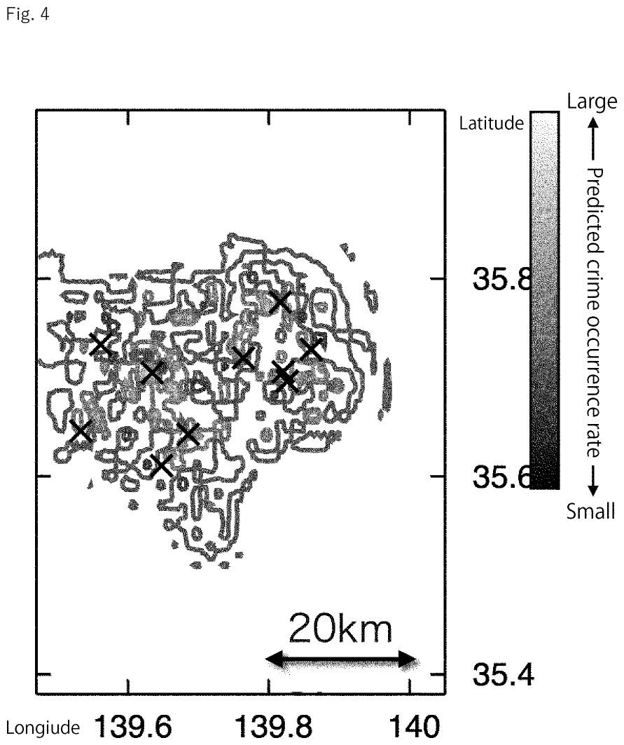

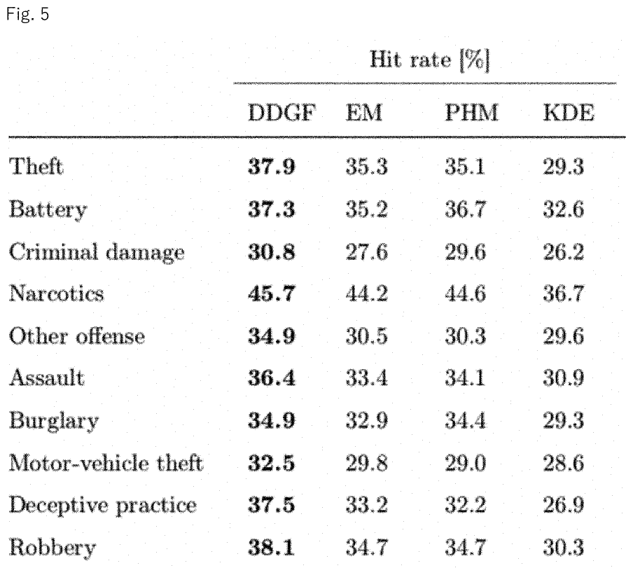

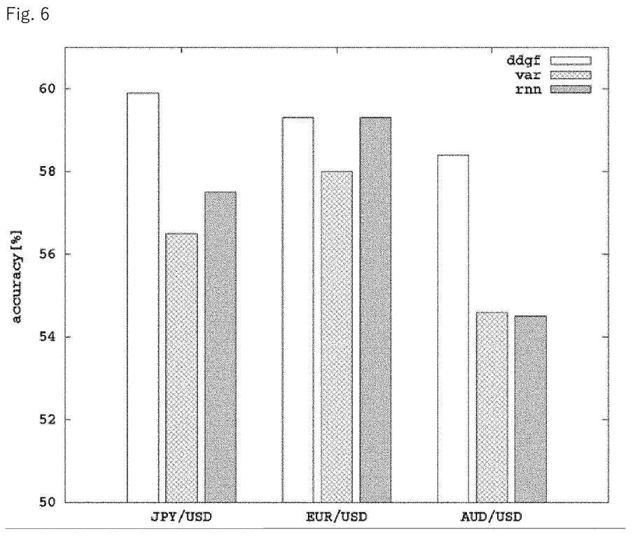

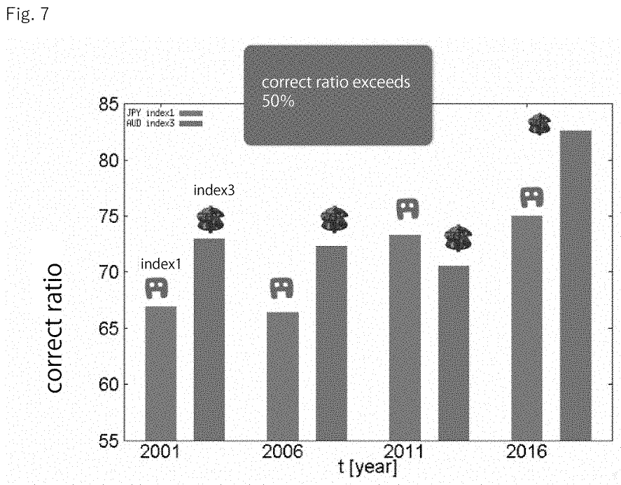

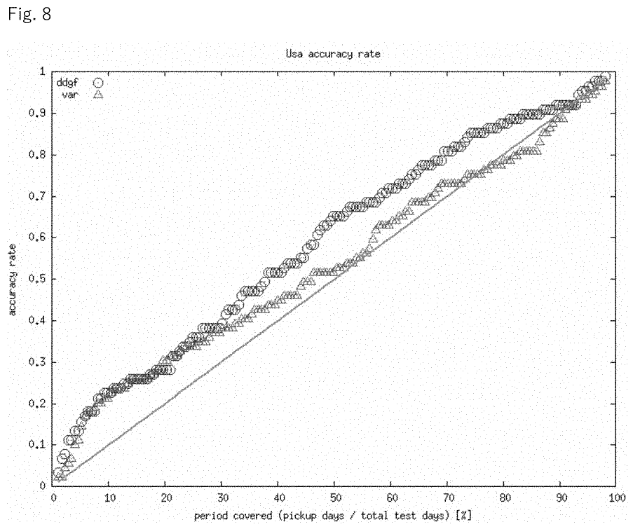

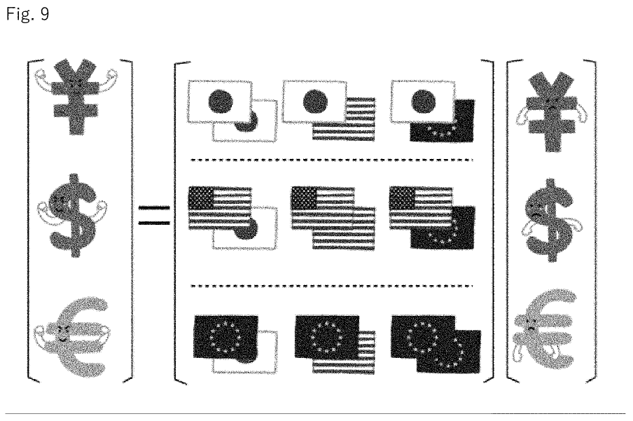

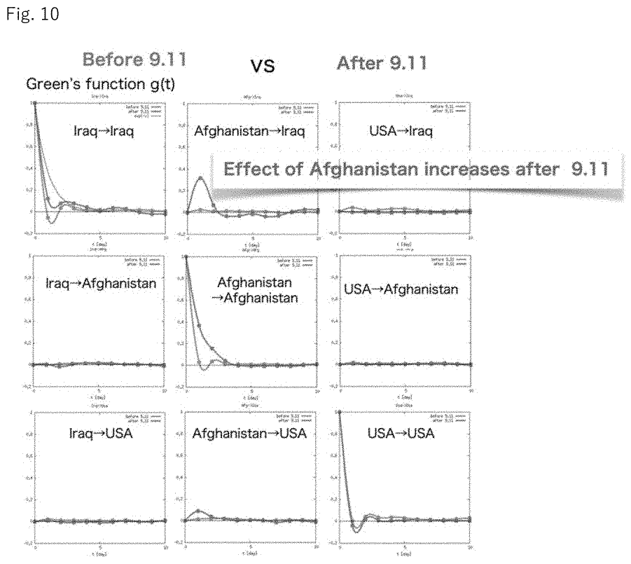

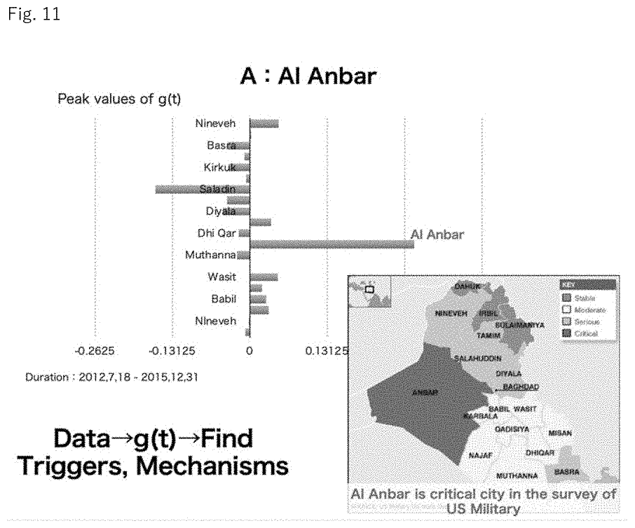

FIG. 4 is a contour line chart showing a crime occurrence prediction result using the event occurrence prediction apparatus of the present embodiment.

FIG. 4 shows contour lines of the predicted crime density calculated using historical data of 738 crimes in a city. For the calculation of the prediction of crime density, the data til the day before the day for prediction. The data of the day for prediction is not used. In addition, the crime events that actually occurred in the prediction period (one day) are shown with markers in FIG. 4.

As shown in FIG. 4, it can be seen that crimes are often actually occurred at positions where the prediction of crime density is high.

FIG. 5 is a table showing the crime occurrence prediction result using the event occurrence prediction apparatus of the present embodiment in comparison with other prediction methods.

The accuracy of the crime occurrence prediction result using the event occurrence prediction apparatus of the present embodiment for ten crime types in Chicago (theft, battery, criminal damage, narcotics, other crime, assault, vehicle, burary, motor-velicle theft, decept) is the highest among the results by the method (Prospective Hotspot Method) where the effect of the crime distance Δx (for example, scaled by half the spatial resolution) and the time Δt (for example, 7 days) of the crime of the past crime occurrence event and by the EM method. The accuracy is compared by dividing the number of predicted crimes among the actual crimes by the actual number of crimes, and in the prediction, the target area for prediction is divided into 250 m square cells, and a certain ratio of the target area is designated as a crime dangerous region.

As described above, according to the present embodiment, it is understood that the prediction accuracy is improved in comparison with the Projective Hotspot Method and the EM method.

Although the above-described embodiment has been described by taking crime as a specific event as an example, it is generally applicable to a phenomenon in which one event induces and cascades a next successive event. In particular, it is expected to show higher accuracy when this induction ratio viewed as a function of time t and space x can be assumed that it has a spatiotemporal correlation and its principle has some degree of stationarity. As such events, for example, the aftershock phenomenon of an earthquake and the damage situation of air strikes have been discussed in the past in relation to the cascade phenomenon. Furthermore, for suicide, pandemic of plague, spread of solicitation/religion/pyramid financing on social networking services (SNS), spam phone call, fashion such as clothing, trends in stock prices/financial products, voting in elections, abnormalities in immune system, consumer buying behavior, clicks on advertisements on websites, demand forecasts such as shopping on the network, matching in such as arranged marriage meeting, smuggling of drugs and money, cyber crimes, terrorism prediction including cyber terrorism, deterioration prediction of infrastructure, software/hardware failure and anomaly detection, it is expected that such a kernel function can be used.

The above-described embodiment predicts the occurrence density of one specific event in the future, but it can also be applied to the prediction of a cascade phenomenon in which multiple variables affect each other. For example, focusing on financial data, the buying and selling of real estate in each country, the transaction of receivables and stocks such as government bonds and corporate bonds, the production and sale of real goods, and the reception of cash for providing services affect each other and the rate of foreign exchange transaction (exchange rate) changes. This change is affected by the state of transaction in the past in a cascade, rather than by the state of real estate in each country at the moment of transaction.

Consider a method of predicting each state of n kinds of specific events. n is a natural number. Here, the state of the specific event may be the occurrence density or a value such as an exchange rate. It is assumed that the state variable of the i-th specific event is given by the function ρ_i (t).

Consider a function vector P(t)={ρ_1 (t), . . . , ρ_i(t), . . . , ρ_n(t)} that gives state variables with n kinds of elements. In the case of a cascade phenomenon, this state variable vector P(t) is given by the mapping F[P(t)+{f}] of this function vector P(t) and the external factor vector {f}.

Similar to the above-described embodiment, the prediction formula construction part can obtain the mapping F[P(t)+{f}] from the state values of specific events occurred in the past and the history data of external factors. Once the function vector P(t) is obtained, the prediction part inputs a value for specifying a future time into the function vector P(t) to predict the state values of specific events.

The above-described embodiment is a case where the function vector P(t) is limited to the function ρ(t, x) of the time t and the region specifying variable x that specifies the region where the specific event occurs. When x is discretized, the entire occurrence density ρ(t, x) of each region indicated by x can be regarded as the function vector P(t).

For example, when predicting the state values of two specific events, it is as follows. Let ρₐ(t) and ρ_{b}(t) be the state functions that give the state values of the two specific events, respectively. In addition, gₐₐ(t), g_{ab}(t), g_{ba}(t), and g_{bb}(t) are introduced as Green's functions expressing the effect of each past state on itself and other specific events. Then, the evolution equation can be written as follows.

$$\begin{matrix}[ Equation 16 ] & \\ \begin{matrix}( \begin{matrix}{ρ}_{a} ( t ) \\ {ρ}_{b} ( t )\end{matrix} ) = γ {\int }_{0}^{t} ( \begin{matrix}{g}_{aa} ( t - {t}^{′} ) & {g}_{ab} ( t - {t}^{′} ) \\ {g}_{ba} ( t - {t}^{′} ) & {g}_{bb} ( t - {t}^{′} )\end{matrix} ) ( \begin{matrix}{ρ}_{a} ( t ) \\ {ρ}_{b} ( t )\end{matrix} ) d {t}^{′} + \\ Δ t ( \begin{matrix}{g}_{aa} ( t ) & {g}_{ab} ( t ) \\ {g}_{ba} ( t ) & {g}_{bb} ( t )\end{matrix} ) ( \begin{matrix}{ρ}_{a} ( t = 0 ) \\ {ρ}_{b} ( t = 0 )\end{matrix} ) \\ ≡ γ ( \begin{matrix}{g}_{aa} ( t ) & {g}_{ab} ( t ) \\ {g}_{ba} ( t ) & {g}_{bb} ( t )\end{matrix} ) ⊗ ( \begin{matrix}{ρ}_{a} ( t ) \\ {ρ}_{b} ( t )\end{matrix} ) + \\ Δ t ( \begin{matrix}{g}_{aa} ( t ) & {g}_{ab} ( t ) \\ {g}_{ba} ( t ) & {g}_{bb} ( t )\end{matrix} ) ( \begin{matrix}{ρ}_{a} ( t = 0 ) \\ {ρ}_{b} ( t = 0 ) ,\end{matrix} )\end{matrix} & ( 7 )\end{matrix}$$

However, it is assumed that there is no effect by external factors. Also, for the sake of simplicity, the variable x indicating the location was ignored. As in the case of a single variate, γ is γ=log 2 when the conditions of the steady solution are considered. Hereinafter, γ and Δt are omitted for the sake of simplicity.

The vector of the state function that gives the state values of specific events is called the feature quantity vector ρ(t), and if this formula is generalized, it can be written as the following determinant.

[Equation 17]

ρ(t)=G(t)⊗ρ(t)+G(t)ρ(t=0) (8)

Here, ⊗ indicates a convolution operation of a function matrix and a vector.

When this equation (8) is Laplace transformed, it becomes the following determinant.

[Equation 18]

ρ(z)=G(z)⊗ρ(z)+G(z)ρ(t=0) (9)

[Equation 19]

ρ(z)=(1−G(z))⁻¹G(z)ρ(t=0) (10)

Here, the following definitions are introduced. [Equation 20]

Φ(z)=(1−G(z))⁻¹G(z) (11)

Then, the inverse Laplace transform of Eq. (9) can be expressed as follows.

[Equation 21]

ρ(t)=Φ(t)ρ(t=0) (12)

In order to obtain Φ(t) from the past data (history data), at first, the element ρᵢ of the equation (11) is divided by the initial state of ρj. Next, the initial state is changed to generate multiple samples, and the statistical mean is calculated. If the time in each initial state is described as to,

$$\begin{matrix}[ Equation 22 ] & \\ 〈 \frac{{ρ}_{j ′} ( t + {t}_{0} )}{{ρ}_{j} ( {t}_{0} )} 〉 = {\sum }_{j ′} {Φ}_{ij ′} ( t ) 〈 \frac{{ρ}_{j ′} ( {t}_{0} )}{{ρ}_{j} ( {t}_{0} )} 〉 & ( 13 )\end{matrix}$$

Here, the matrix c is introduced.

$$\begin{matrix}[ Equation 23 ] & \\ {c}_{j ′ j} ( t ) = 〈 \frac{{ρ}_{j ′} ( t + {t}_{0} )}{{ρ}_{j} ( {t}_{0} )} 〉 & ( 14 )\end{matrix}$$

Using this matrix c, the following equation is obtained.

[Equation 24]

c(t)=Φ(t)c(t=0) (15)

In short,

[Equation 25]

Φ(t)=c(t)c(t=0)⁻¹ (16)

When Eq. (11) is transformed using this Laplace transform Φ(z), the final Green's function is as follows.

[Equation 26]

G(z)=Φ(z)(γΦ(z)+Δt)⁻¹ (17)

Here, the dependence on γ and Δt is clarified.

G(t) is obtained by inverse Laplace transform of this. By using the G(t) thus obtained, the past occurrence density ρ(t=0) is substituted into the equation (8) to obtain the occurrence density ρ(t) at time t.

FIG. 6 is a graph comparing the correct ratio of the exchange rate prediction according to the present embodiment with other prediction methods.

ddgf is the result of using this embodiment. var shows the result by another prediction method, vector autoregressive model. rnn shows the result by LSTM Multimodal Long Short-Term Memory, which is an extension of RNN (Recurrent Neural Network). Here, the correct ratio is the ratio of correct prediction regarding the positive/negative compared with the pivot point rate (PP rate) of the previous day where the PP rate is the average value of the high price+the low price+the closing price.

FIG. 6 shows that the present embodiment has an accuracy equal to or higher than that of VAR and LSTM.

FIG. 7 is a graph showing the annual change in the correct ratio of the exchange rate according to the present embodiment.

Here, the index 1 is for the Japanese yen to the US dollar rate, and the index 3 is for the Australian dollar to the US dollar rate, each index is a ratio of the closing price/opening price from the previous day. In both index 1 and index 3, the correct ratio exceeds 50% in each year. Furthermore, it can be seen that the percentage of correct ratio increases as the history data in the past increases, that is, as the year progresses.

FIG. 8 is a graph comparing the prediction accuracy of the occurrence of terrorism in the United States according to the present embodiment with other prediction methods.

DDGF is the result of using this embodiment. var shows the result by another prediction method, vector autoregressive model. Here, the prediction accuracy is a value obtained by dividing the number predicted to occur by the number actually occurred.

FIG. 8 shows, the measurement results of accuracy of prediction for the occurrence of terrorism in the United States, for example, using time-series data on how many terrorist attacks occurred daily from 2001 to 2015 in the three countries of North America, Iraq, and Afghanistan is selected, and the DDGF method of the present embodiment. For example, among the data of the target period, first ⅔ is selected as training data and latter ⅓ is selected as test data.

As shown in FIG. 8, according to the present embodiment, higher prediction accuracy can be obtained than the existing method.

As described above, in the present embodiment, it can also be used for predicting a cascade phenomenon in which past states of a plurality of events influence each other.

FIG. 9 is a diagram schematically showing the concept of the multivariate DDGF method in the present embodiment.

Furthermore, in the multivariate DDGF method, the G matrix can interpret how the effects propagate between different variables. For example, when the variables are three variables of yen, dollar, and euro, the configuration of the G matrix as shown in FIG. 9 can be considered. The first row and first column describes the propagation of the effect from yen in the past to yen in the future circle, and the first row and the second column describes the propagation of the effect from yen in the past to dollar in the future. In other words, by looking at each element of the G matrix, it is possible to understand at what time scale the effect propagates between different variables.

FIG. 10 is a graph group showing the analysis results of the events according to the present embodiment.

Determining the G matrix from the data is also to get a tool for analyzing the phenomenon. As an example, the data on the number of daily terrorist attacks in Iraq, the United States, and Afghanistan are divided before and after the 9/11 incident to calculate the G matrixes. It can be seen that the propagation of effect from Afghanistan to Iraq and from Afghanistan to Afghanistan changed significantly at 9/11.

FIG. 11 is a diagram showing the results of analyzing the occurrence of terrorism events in each state of Iraq and the whole of the United States using this embodiment.

By selecting variables across Iraqi states and the United States, it is also possible to analyze which state of Iraq has the greatest impact on the USA.

### EXPLANATION OF REFERENCE SYMBOLS

10: prediction formula construction part, 12: history data group storage part, 14: kernel function construction part, 16: kernel function storage part, 18: prediction formula construction part, 20: prediction formula storage part, 22: history data receiving part, 24: mobile terminal, 26: police system, 30: prediction part, 40: display part.

1. An event prediction apparatus predicting feature quantity vector ρ(t) at time t based on history data of specific events occurred in a passed, the apparatus comprising;
a prediction formula construction part defining a matrix c(t) as
$${c}_{j ′ j} ( t ) = 〈 \frac{{ρ}_{j ′} ( t + {t}_{0} )}{{ρ}_{j} ( {t}_{0} )} 〉 ,$$
obtaining
Φ(t)=c(t)c(t=0)⁻¹,
obtaining Laplace transform Φ(z) of Φ(t),
obtaining Green's function G(z) using a constant gamma as
G(z)=Φ(z)(γΦ(z)+Δt)⁻¹,
and obtaining G(t) by applying Laplace transform to the G(z); and
a prediction part using G(t) obtained by the prediction formula construction part and obtaining the feature quantity vector ρ(t) of the specific events by inputting a time t in a future into
ρ(t)=γG(t)⊗ρ(t)+ΔtG(t)ρ(t=0).

2. An event prediction method predicting feature quantity vector ρ(t) at time t based on history data of specific events occurred in a passed, the method comprising;
a prediction formula construction step defining a matrix c(t) as
$${c}_{j ′ j} ( t ) = 〈 \frac{{ρ}_{j ′} ( t + {t}_{0} )}{{ρ}_{j} ( {t}_{0} )} 〉 ,$$
obtaining
Φ(t)=c(t)c(t=0)⁻¹,
obtaining Laplace transform Φ(z) of Φ(t),
obtaining Green's function G(z) using a constant gamma as
G(z)=Φ(z)(γΦ(z)+Δt)⁻¹,
and obtaining G(t) by applying Laplace transform to the G(z); and
a prediction step using G(t) obtained by the prediction formula construction part and obtaining the feature quantity vector ρ(t) of the specific events by inputting a time t in a future into
ρ(t)=γG(t)⊗ρ(t)+ΔtG(t)ρ(t=0).

3. An event prediction system predicting feature quantity vector ρ(t) at time t based on history data of specific events occurred in a passed, the system comprising;
a prediction formula construction part defining a matrix c(t) as
$${c}_{j ′ j} ( t ) = 〈 \frac{{ρ}_{j ′} ( t + {t}_{0} )}{{ρ}_{j} ( {t}_{0} )} 〉 ,$$
obtaining
Φ(t)=c(t)c(t=0)⁻¹,
obtaining Laplace transform Φ(z) of Φ(t),
obtaining Green's function G(z) using a constant gamma as
G(z)=Φ(z)(γΦ(z)+Δt)⁻¹,
and obtaining G(t) by applying Laplace transform to the G(z);
a prediction part using G(t) obtained by the prediction formula construction part and obtaining the feature quantity vector ρ(t) of the specific events by inputting a time t in a future into
ρ(t)=γG(t)⊗ρ(t)+ΔtG(t)ρ(t=0);
a terminal transmitting an occurrence of the specific event as the history data; and
a server making the prediction formula construction part to obtain G(t) again when a new history data is obtained by receiving the new history data from the terminal.
